(19) United States
(12) Patent Application Publication
(10) Pub. No.: US 2011/0266272 A1
(43) Pub. Date: Nov. 3, 2011

(54) Steam Generator System

(76) Inventors: Michael G. Colburn, Burlington, VT (US); Stephen J. Bogner, Colchester, VT (US)

(21) Appl. No.: 13/023,891

(22) Filed: Feb. 9, 2011

Related U.S. Application Data
(60) Provisional application No. 61/343,612, filed on Apr. 30, 2010.

(51) Int. Cl. A21B 1/22; H05B 3/60

(52) U.S. Cl. 219/401; 392/322

(57) ABSTRACT

A steam generator system for rapidly creating steam by a direct conversion of electrical energy to heat in ionic, water molecules. The system generally includes a supply of water having an ionic content to be received by a heating tank for contacting current-carrying electrodes to produce steam in a continuous, intermittent, or a determinant amount, via a control system. Also possibly included are a water reservoir, filter, pump, check valve, and various optional embodiments of the heating tank. The present invention also permits for controlling the supplied current input to the electrodes by the combination of ionic content added to the water, water level as controlled by the pump, and a phase angle controller and current sensor of an electrical circuit.

### CROSS REFERENCE TO RELATED APPLICATIONS

I hereby claim benefit under Title 35, United States Code, Section 119(e) of U.S. provisional patent application Ser. No. 61/343,612 filed Apr. 30, 2010. The 61/343,612 application is currently pending. The 61/343,612 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a steam generator and more specifically it relates to a steam generator system for rapidly creating steam by a direct conversion of electrical energy to heat in the water molecules and in current-controlled sequences to deliver a determinant amount of steam, intermittent amounts of steam or a continuous amount of steam.

2. Description of the Related Art

Any discussion of the related art throughout the specification should in no way be considered as an admission that such related art is widely known or forms part of common general knowledge in the field.

In steam use applications the need for rapid generation and replacement of steam is often required for speed of the work being performed by the steam. Different work to be performed by steam can require a determined amount of steam, intermittent amounts of steam or a continuous amount of steam. Food cooking is one such application where it is necessary to provide a continuous amount of steam to rapidly cook or reheat bulk food in the quantities needed for serving large numbers of people, such as in a restaurant or for banquet feeding. In other applications where portions of food are to be reheated for individual servings such as sandwich meats, short blasts of steam in small amount, repeated at intervals are preferable. Where a single function is to be performed for a specific amount of time a determined amount of steam is often preferable.

In steam generation by an electrical resistance element, electrical energy must first heat an electrical resistance element then its casement and then the water to be used to produce steam. An electrical resistance element is generally enchased in a sheath of metal or other material which is heated by the resistance element when the element is submerged in water to generate steam. A delay in heating the water to sufficient temperature to generate steam occurs due to the conduction of heat through layers of material and then into the water molecules.

In attempts to speed steam generation, electrical elements are often oversized and overpowered in order to quickly heat the sheathing so that the sheathing can then heat the water, which generally causes excessive energy use. When steam is required in a device with electrical resistance elements, full power is applied to the element, in this way the surface temperatures of the element and its sheathing become much hotter than the water and heat transfer is faster. When steam is no longer needed, energy is removed from the resistance element, however heat in the resistance element and casement continues to transfer to the water and is wasted. In this way more energy is used than would be necessary if a direct application of energy to heat was provided in just the amount of energy needed to supply the amount of steam necessary to perform the work required.

Other problems are created by heating the element and sheathing to a temperature much hotter than the water to be heated. Dissolved solids such as calcium carbonate and magnesium are percolated out of the water and these particles adhere to the surface of the element sheathing, thus forming a layer of deposits called lime scale on the heat transfer surface. These lime scale deposits become another layer of heat transfer and reduce the speed of heat transfer further. The lime scale then causes more energy use for the work required. Lime scale is also a major factor creating maintenance and service requirements for steam generation devices.

In continuous steaming applications, steam generators having storage for a quantity of water are used. The size of the reservoir for water storage is based on the maximum amount of steam generation required in a period of time. The generating of steam then requires heating this entire mass of stored water to near steam generation temperatures in order to provide the required amount of steam as quickly as possible. Heating this entire quantity of water is required in continuous steaming applications to offset the amount of time required to take water to steam in a continuous supply using electrical resistance elements. Energy is wasted by heating the entire supply of stored water. After water in the heated reservoir is heated to generate steam, new water is supplied to the water storage cooling the entire amount of water. When new water is added the temperature of the entire quantity of water is reduced and must be reheated to the desired maintenance temperature, again wasting energy.

Attempts to speed the generation of steam in a steam generator with water storage have included the use of a pressurized housing in which the water can be heated and maintained at a higher temperature so that its release to steam use will flash the water from superheated water to steam. Devices with steam generation and pressurized water are generally complex, heavy due to the weight of components and due to the stored supply of water and are prone to service and maintenance issues. A great deal of energy is expended to reheat and maintain the water supply at a temperature ready to produce steam.

In an alternate steam generating method serving the need for rapid steam generation devices, a nozzle supplies a small amount of water as a spray against a hot surface where it flashes to steam. In this way a small quantity of steam is produced almost instantly and then is used for the application intended. Additional quantities of water are sprayed against the hot surface intermittently to provide additional quantities of steam for the intended purpose. The hot surface is heated by an encased electrical element or in some cases water is sprayed directly on an electrical element encased in sheathing. This method of steam generation provides an intermittent amount of steam but not a continuous amount of steam. In this solution the amount of steam that can be created at one time is limited first by the quantity of water contained in each spray and then by the surface temperature of the surface on which the water is sprayed. Repeated sprays can create additional steam but sprays must be delayed until the heated surface has had a chance to recover adequate temperature to flash more water to steam, limiting the amount of steam that can be generated. In some cases the electrical element provided to heat a surface or provided as a flashing surface is increased in size to allow for faster recovery in order to flash more water to steam in a given time, wasting energy.

In instances where the need for steam is often unpredictable, the heated surface is maintained in a hot surface condition in order to be ready for steam production when required, this also wastes energy. In this solution, the dissolved solids of the water supply are given up to the heated surface when the water is flashed to steam. The dissolved solids form a lime scale coating on the flashing surface causing it to become less efficient at heat transfer. This results in the need for additional energy to heat the surface and additional time to reach a temperature capable of generating steam. These conditions result in a reduction in the amount of steam that can be generated and the speed at which steam can be generated. The buildup of lime on the surface eventually leads to the need for maintenance or repair.

Because of the inherent problems with the related art, there is a need for a new and improved steam generator system for rapidly creating steam by a direct conversion of electrical energy to heat in the water molecules and in controlled sequences to deliver a determinant amount of steam, intermittent amounts of steam or a continuous amount of steam.

### BRIEF SUMMARY OF THE INVENTION

A system for rapidly creating steam by a direct conversion of electrical energy to heat in the water molecules and in controlled sequences to deliver a determinant amount of steam, intermittent amounts of steam or a continuous amount of steam. The invention generally relates to a supply of water having an ionic content to be received by a heating tank for contacting current-carrying electrodes to produce steam in a continuous, intermittent, or a determinant amount, via a control system. Also possibly included are a water reservoir, filter, pump, check valve, and various optional embodiments of the heating tank. The present invention also permits for controlling the supplied current input to the electrodes by the combination of ionic content added to the water, water level as controlled by the pump, and a phase angle controller and current sensor of an electrical circuit.

According to the present invention the ionic content in water is preferably adjusted before use in steam generation. Since the ionic content acts as conductance and since the conductance of the water is increased by the addition of ionic content before resupply to the steam generator housing, the conversion of energy to heat occurs in the water molecules very rapidly once current is passed through the water. This is advantageous because no energy is wasted by heating and maintaining a quantity of water hot to produce steam. No energy is wasted by maintaining a surface hot for the purposes of flashing water to a small quantity of steam.

The present invention uses only the energy required to convert an amount of water to steam at the point in time when the steam is required. In this way energy used for standby conditions are likewise eliminated. Steam generation is controlled by the resupply of a quantity of water in electrical communication. The present invention can produce a small quantity of steam intermittently or a continuous quantity of steam by continuous supply of water or a fixed quantity of steam determined by a quantity of water in communications with electrical current until consumed.

In the present invention the water used to generate steam provides the electrical path between legs of an electrical supply with the water completing a circuit, when a circuit is completed by the water, current begins to flow through the water and energy is consumed. This energy is converted to heat in the water molecules when it encounters resistance which is provided by the dissolved solids in the water.

The conversion of energy to heat is based on the amount of resistance in the water. With an adjusted amount of resistance provided by the ionic content added to the water, the conversion of energy to heat can be almost instant. It is also converted at a very high efficiency of energy to heat. The current applied to water, charges all molecules in the entire mass of water simultaneously and heating is volumetric increasing the speed of transfer from water to steam. The speed of conversion is a direct ratio of the amount of water, the amount of current flowing in the water and the amount of resistance in the water.

The invention consumes energy only when water is present for the purposes of converting to steam and then only uses energy until the water provided is converted to steam. When all the water is transformed to steam the electrical circuit is interrupted and no energy is consumed. With water present and with energy removed, steaming stops instantly. In this invention there are no surfaces hotter than the water itself and due to this condition the percolation of dissolved solids from water do not create lime scale, thus avoiding regular maintenance or repair.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

Therefore, a primary object of the invention is to provide a steam generator for providing an ongoing supply of freshly generated steam similar to a steam generator for powering a cooking appliance or a small amount of steam at timed intervals such as a flash hot plate steam generator or a fixed amount of steam while achieving speed of generation in each instance as well as energy efficiency and reduced maintenance.

In addition, it would be advantageous to provide a steam generating device that was capable of rapidly creating a continuous amount of steam or a small amount of intermittent steam or a determinate amount of steam without the necessity of keeping a quantity of water hot or a surface hot for flashing water to steam.

It would also be advantageous to provide a steam generating device that permits for controlling current input to the heating tank by the combination of ionic content added to the water, water level as controlled by the pump, and a phase angle controller.

It would also be advantageous to provide a steam generating device that would provide steam very rapidly by the direct conversion of energy to heat in water molecules.

It would also be advantageous to provide a steam generating device to heat just the amount of water desired to create just the amount of steam desired, quickly and efficiently.

It would further be advantageous to provide a steam heating device that would convert water to steam faster by the addition of ionic content to the water.

It would further be advantageous to provide a steam generating device that interrupted the electrical supply when a precise amount of water was evaporated to steam.

It would further be advantageous to provide a steam generating device that eliminates the problems of maintenance and repair associated with lime scale build up on parts in a steam generation system.

It would further be advantageous to provide a simple steaming device that was light and required very few connections for use independently of appliances and could be attached to a particular appliance when steam was required.

It would further be advantageous to provide a steam generator that was maintained in a steam ready condition without the consumption of maintenance energy.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exemplary flow diagram of the present invention.

FIG. 2 is an exemplary circuit diagram of the present invention.

FIG. 3 is an upper perspective view of an exemplary tank.

FIG. 4 is a sectional view of exemplary tank in use.

FIG. 5 is an exemplary illustration of another embodiment of the present invention.

FIG. 6 is a sectional view of the tank illustrated in FIG. 5.

FIG. 7 is an exemplary illustration of a filter.

FIG. 8 is an exemplary illustration of yet, another embodiment of the present invention.

FIG. 9 is an exemplary illustration of a consumer embodiment of the present invention.

### DETAILED DESCRIPTION OF THE INVENTION

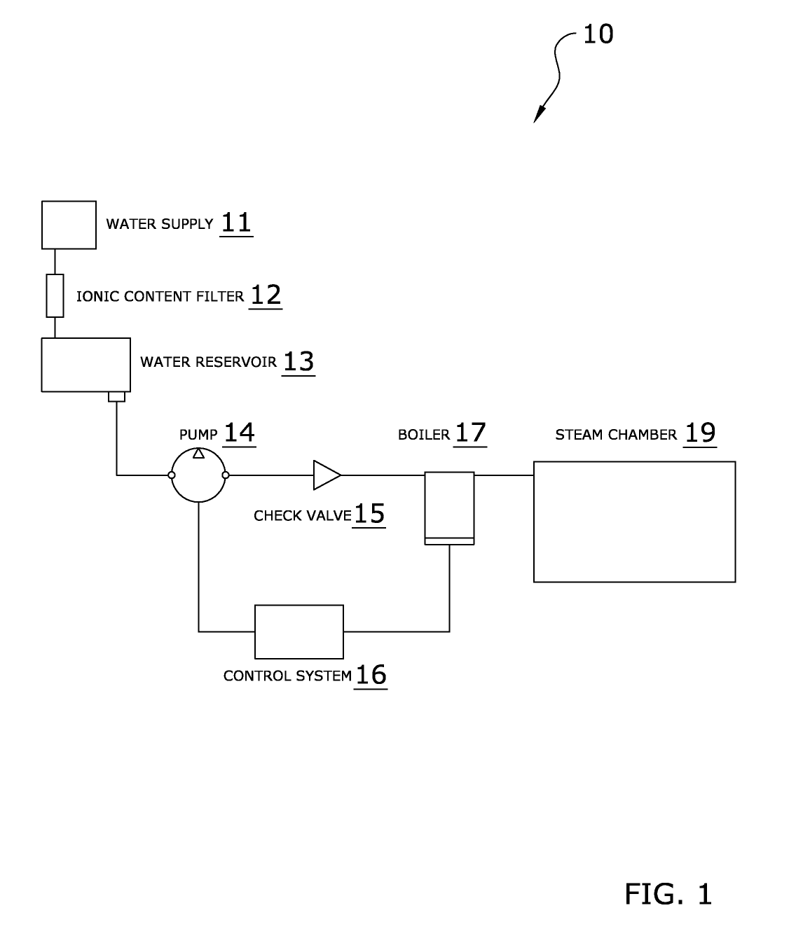

Turning now descriptively to the drawings, in which similar reference characters denote similar elements throughout the several views, FIGS. 1 through 9 illustrate a steam generator system 10 which comprises a supply of water 11 received by a heating tank 17 for producing steam in a continuous, intermittent, or a determinant amount, via electrodes and a control system 16. The steam is rapidly created via direct conversion of electrical energy to heat in the water molecules that are to become steam. Also possibly included are a water reservoir 13, filter 12, pump 14, check valve 15, and various optional embodiments for the heating tank 17.

FIG. 1 illustrates an exemplary flow diagram of the present invention illustrating a water reservoir 13 utilized for holding supply of water 11 to produce steam. It is appreciated that in an alternate embodiment, a water connection could be provided for a continuous supply in place of or in addition to the water reservoir 13. The water reservoir 13 can be of a blow molded or injection molded plastic or can be of another material suitable for the storage of water. The water supply 11 is adjusted in ionic content by passing water through a filter 12 or by the addition of an amount of sodium chloride in an approximate ratio of approximately ¾ of a gram per gallon of water. This addition of an ionic material to water to increase resistance is described in patent publication “Rapid Liquid Heating” of Colburn et al. (U.S. Patent Publication No. 2010/0040352) which is incorporated by reference herein.

The water filter 12 is so constructed as to direct water flow through a series of holes and through material content in order to add ionic content to the water as it passes through the filter 12. The material of the water filter 12 construction may be of any material suitable for contact with water and with the ionic content within the filter 12. As water is added to a pour thorough component of the water reservoir 13, the flow is controlled by hole size to allow adequate contact time between water and the ionic content to dissolve ionic content to flow through discharge holes into storage in the water reservoir 13. The ionic content may be comprised on one or more potable ionic elements and may contain a charcoal filtering element to remove chlorine or other components from the water added. The amount of sodium chloride added to the water and the amount of dissolved solids in the water supply 11 to the reservoir 12 will help establish a higher level of current flow than when sodium or dissolved solids are not available in the water supply 11. This is advantageous since in operation it is important to convert electrical energy to heat in the water as quickly as possible to provide steam to the steam compartment 19 to do the work desired.

The water reservoir 13 is connected to a pump 14 which in turn is connected to a one way check valve 15 connected to the heating tank 17. The pump 14 is controlled by on and off signals received from a control system 16, the longer the pump 14 is on the more water that is pumped to the interior of the heating tank 17 and results in more water in communications between the electrode and the conductive tube of the tank 17. The check valve 15 allows water flow to reach the tank 17 in amounts required by the control system 16 but prevents steam from flowing back to the pump 14. The output of the heating tank 17 is directed to a steam chamber 19, such as a cooking appliance, compartment, or other device that would utilize steam. The connections between components that permit water and steam flow may comprise pipe, tubing, or other suitable structural components. Also illustrated connected to the tank 17 is a positive connection box which receives a positive power line to connect to the electrode.

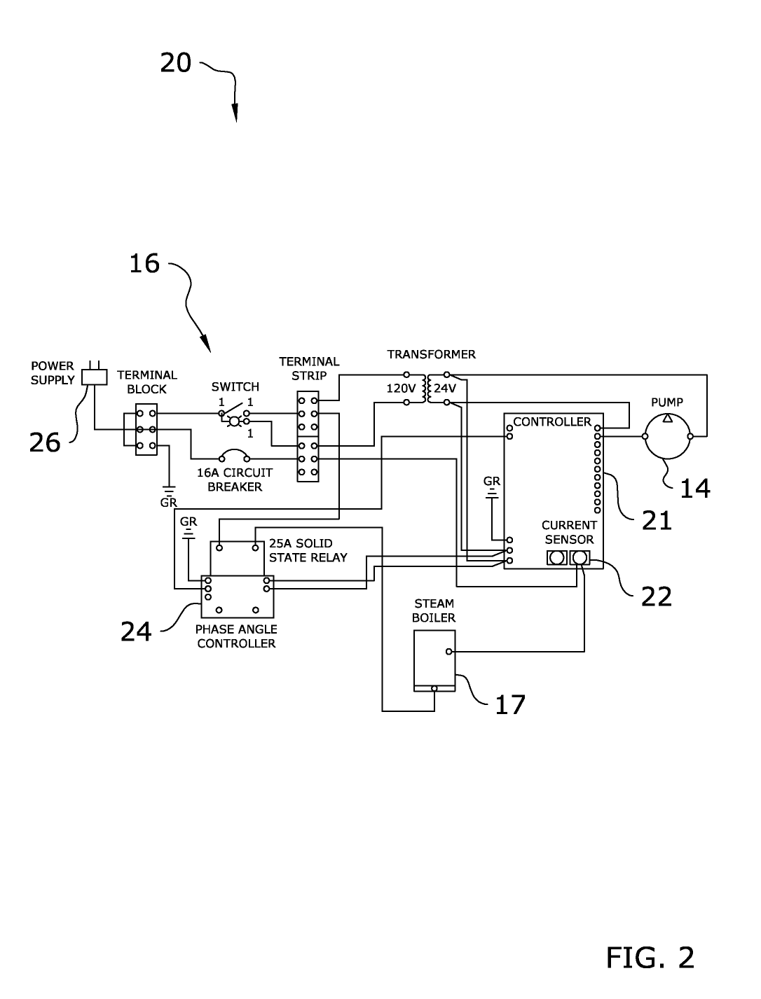

FIG. 2 illustrates an exemplary diagram of an electrical circuit 20 used with the present invention. The electrical circuit 20, in addition to operating the pump 14, is used to monitor and control the current load to maintain steaming function and to not exceed a current load set point which would disrupt current flow by activating a disconnect breaker. It is also desirous to maintain the relatively high, close to limit current in order to generate the desired amount of steam for the desired amount of steaming time without interruption. The amount of dissolved solids and sodium chloride in the water could easily reach a level where a current load limit could be achieved and exceeded, if other controls were not in place.

The electrical circuit 20 is connected to a power supply 26, such as a 120 v, 20 A NEMA 5-20P; however it is appreciated that other power supplies may be appreciated. As also illustrated in FIG. 2, a current sensor 22 is located on a controller 21, wherein the current sensor 22 reads the level of current being provided to the heating tank 17 and is programmed to supply current to the pump 14 based on the current level programmed into the controller 21. When the current level drops, the pump 14 is activated and supplies an amount of water to the heating tank 17, which in turn rises the level of current being used by the heating tank 17. When the current level rises to a set level the current sensor 22 interrupts the power to the pump 14 and the water supply 11 is interrupted. Since the control is preset to operate at the desired level of current to maximize steam generation rapidly, the current sensor 22 and the pump 14 work together to adjust and maintain a level of current near the maximum set point. This operation also adjusts for over ionization of the water by adjusting the water level in communications with electrical current and still maintains the desired level of current flow and steam generation.

As illustrated in FIG. 2, the current sensor 22 is also wired into a phase angle controller 24. The supplied power is one of the potential variables in the current flow. The phase angle controller 24 operates as a fine tuning adjustment to current and works in consort with the pump 14. The current level is tuned based on set inputs set in the control algorithms on the controller software. The water conductance and water level controlled by the pump 14 works to maintain a high working current. However, at a peak currents, light variations can overshoot a set point and cause an electrical disconnect by opening a breaker. The phase angle controller 24 in conjunction with the current sensor 22 recognizes approaching set points as directed by the algorithms and as instructed by the algorithm to shave width from the sine wave to maintain the high current flow rate but not exceed the set point limit. In this way the current sensor 22, the phase angle controller 24, the water level as provided by the pump 14 and the conductivity provided by the water work together to achieve a high level of current and maintain a high level of current without overshooting a set point limit. The control system 16 of FIG. 1 generally includes all electrical components of FIG. 2 except the tank 17 having the electrodes and pump 14 which are given separate reference numerals in FIG. 1.

In operation, by controlling the quantity and frequency of the water supply 11 to the tank 17 the system can generate a continuous supply of steam by pumps of ionic water at an interval frequency to maintain a quantity of water in the tank 17 for steam generation, or steam at intervals of time such as a quantity of water every ninety seconds to provide an intermittent supply of steam or a determinant quantity of steam by the amount of water provided without any additional water supply, such as provide one tenth liter of water and steam until depleted and no resupply.

When water is supplied to tank 17, water will seek a common level between the electrodes. Current will only flow between positive and neutral electrodes or components when a connection between the electrodes is made by the water being supplied by the pump. In this way steam generation ceases when either all water is evaporated to steam and not additional water is provided or when the electrical power to the electrodes is removed. Power is never used to maintain a supply of water hot for steaming and since only a small supply of water is required to evaporate to steam at any instant, steaming is very fast. Speed is also enhanced due to the added ionic content of the water converting electrical energy to heat more quickly. As steam is generated it flows to the steam chamber or appliance. A steam valve is eliminated since the supply of steam is determined by the amount of water and the control system 16.

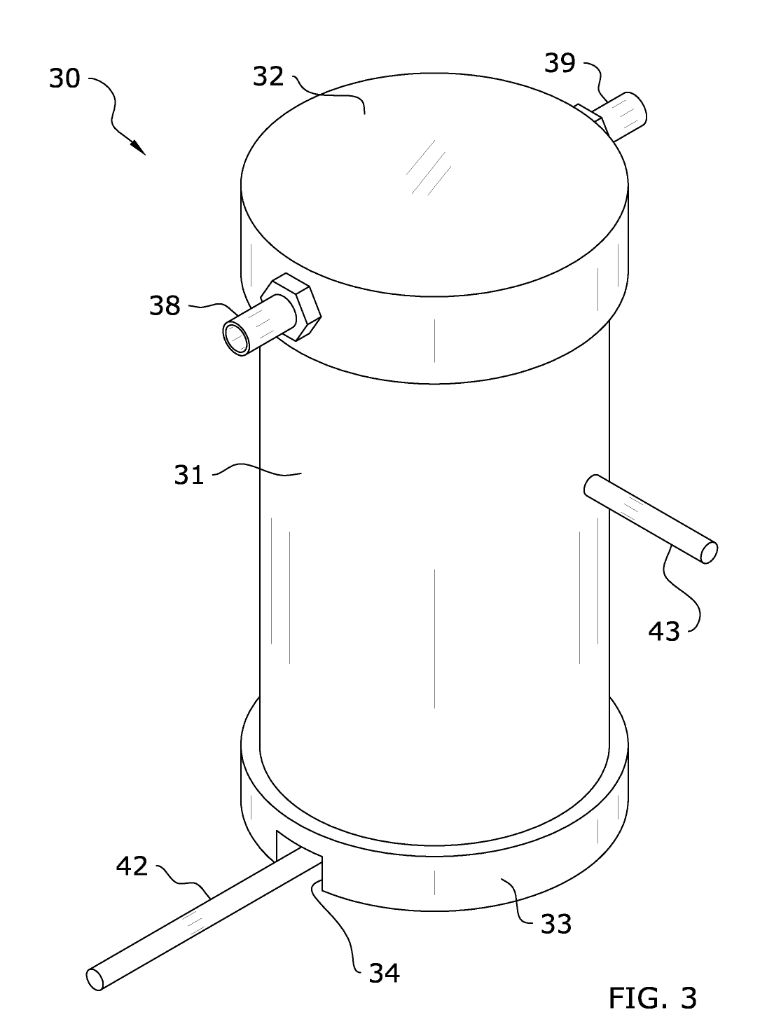

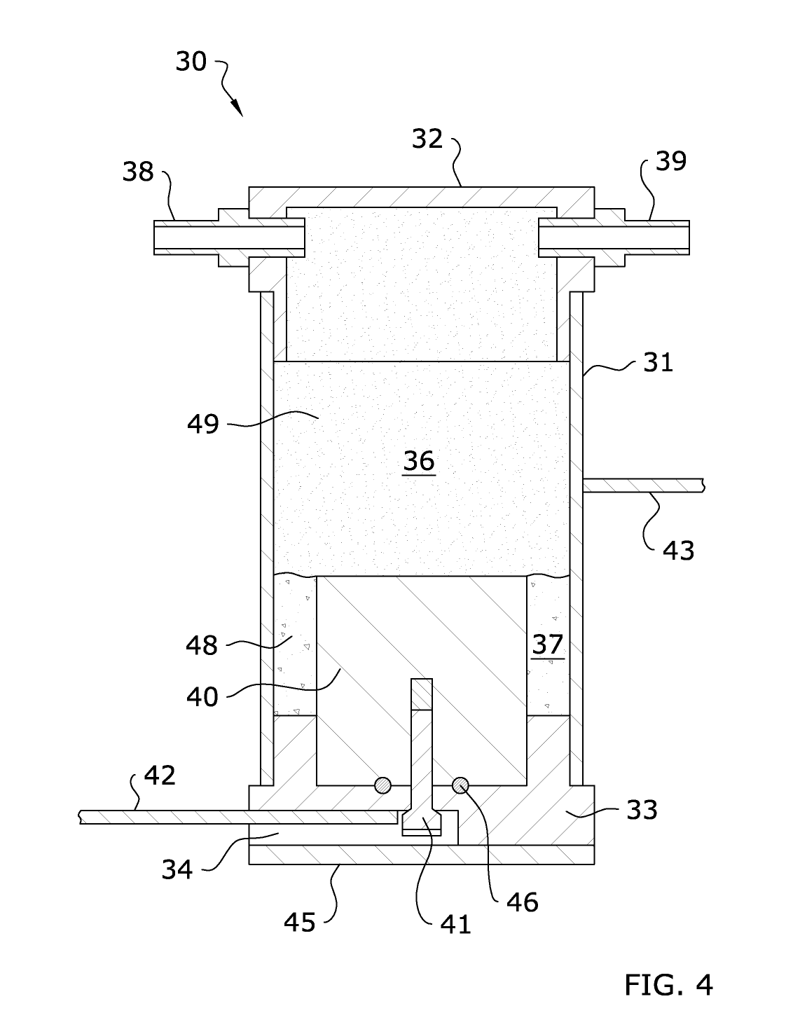

FIGS. 3 and 4 illustrate a first exemplary embodiment of a tank designated reference numeral 30 which receives water 48 and outputs steam 49. The tank 30 includes a shell 31 comprised of a metallic material, such as titanium or other conductive and non-corrosive material, the shell 31 generally being tubular in shape and connected to a neutral line 43 of an electrical circuit 20. The shell 31 is fitted with a first end cap 32 and a second end cap 33, preferably constructed of a non-conductive material, such as polypropylene, to form a water-tight, sealed interior space.

The first end cap 32 is generally fitted with an input fitting 38 for receiving water 48 within the interior space and also with an output fitting 39 for outputting steam 49 for the required purpose, such as heating food. The input fitting 38 and the output fitting 39 are generally comprised of a tubular, barbed structure which is adapted to receive and fluidly connect to a hose, pipe or other transferring medium.

The second end cap 33 is also fitted with an electrical fitting 41 for receiving a positive power line 42 of an electrical circuit 20. The positive power line 42 extends within a channel 34 along the bottom surface of the second end cap 33, or other opening extending within the second end cap 33, that is not connected to the interior space. The electrical fitting 41 may be of various types, all which permit electrical connection thereto and transfer the electrical connection to the electrode 40 within the interior space of the tank 30. A non-conductive, such as polycarbonate material, cover 45 is installed upon the second end cap 33 and over the electrical connection of the electrical fitting 41 and the positive power line 42. The electrode 40 is located within the interior space of the tank 30 and is sealed along a lower end with an O-shaped, silicone seal ring 46. The electrode 40 is generally comprised of a graphite material; however other conductive electrode(s) may be utilized as appreciated. A gap 37 is formed between the outer circumference of the electrode 40 and the inner circumference of the conductive shell 31 for current flow.

The interior space of the tank 30 includes a lower space defined as the gap 37 and an upper space defined as the expansion chamber 36, each connected. In operation of the tank 30, water 48 is fed to the interior space in measured amounts and fills the communications gap 37 between electrode 40 and the conductive shell 31. With water 48 in electrical communication, current can flow between the two legs of an electrical circuit. The conductance of the water 48 completes the electrical circuit. The dissolved solids or ionic material in the water 48 provides resistance which creates heat that boils the water 48 to create steam 49 in this invention as illustrated in FIG. 4. The manipulation of the ionic content of the water is described in patent publication “Rapid Liquid Heating” of Colburn et al. (U.S. Patent Publication No. 2010/0040352) which is incorporated by reference herein.

The space above the electrode 40 in the interior space serves as an expansion chamber 36 for water 48 vaporizing to steam 49, which due to the confinement creates pressure and then forces steam 49 to exit from the outlet 39 and enter the chamber 19 or receptacle where it is intended to do work. The space is adequate to provide enough steam 49 to maintain a continuous supply of steam 49, when desirable, to the steam chamber. This is in contrast with flash type steamers that can only provide intermittent steam by flashing water on a heated plate.

The variables to steam generation are the size of the gap 37 between the conductive shell 31 and the conductive electrode 40, the amount of water 48 in the gap 37, the conductance and resistance of the water 48 in the gap 37 and the applied electrical load. The present invention varies the water level in communications with the power legs of the electrical circuit 20 as one method of adjusting and controlling the current flow. In the preferred embodiment, the gap 37 between electrode 40 and the conductive shell 31 is ¼ inch, the height of the electrode 40 material is at 33 percent of the interior space height, and the total height of the interior space is approximately 5 inches. However, it is appreciated that various alternate embodiments, shapes, and sizes may be appreciated.

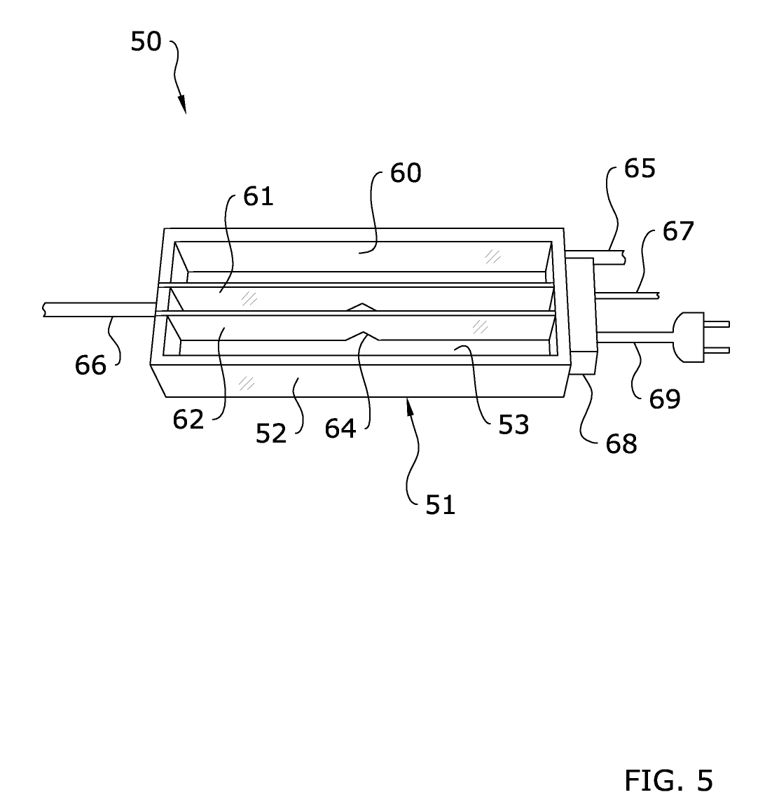

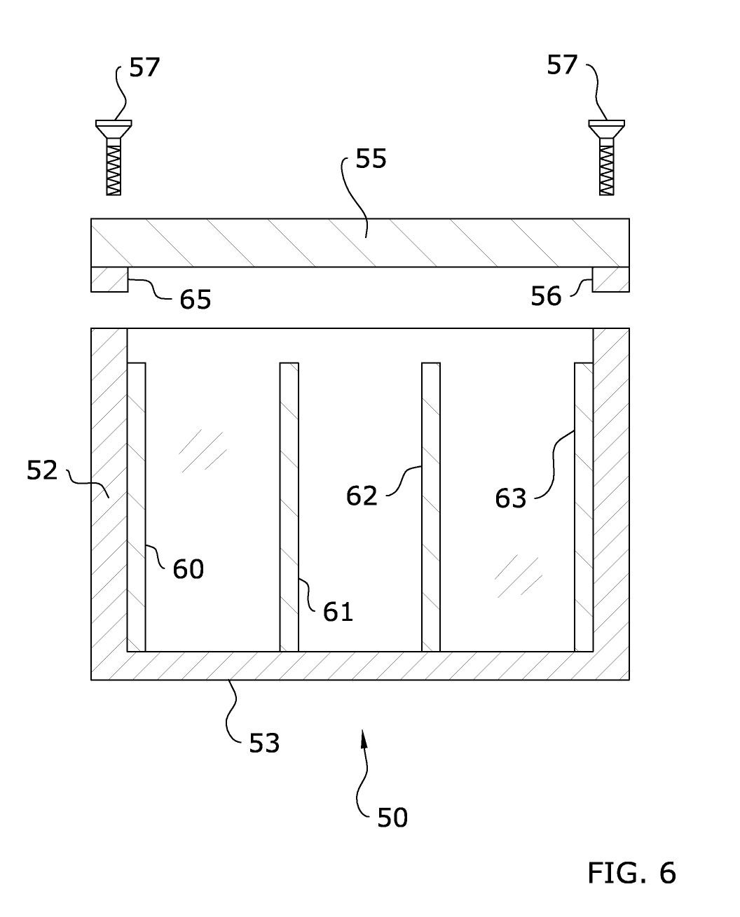

FIGS. 5 and 6 illustrate another embodiment of the tank designated reference numeral 50. The tank 50 includes a housing 51 constructed of any non-electrically conductive material such as polypropylene or other material that will not convey electrical current or of a material such as metal that is coated with a non-conductive material such as steel coated with PTFE coating. The housing 51 includes sidewalls 52 and a bottom 53 to form a rectangular, box-shape and a rectangular interior space; however other shapes and sizes may be appreciated. The housing 51 shape with an open wall is then closed with a steam housing cover 55 and is sealed with a gasket 56. The cover 55 is then secured by securing means, such as fasteners 57, to seal the housing 51 shut in a water-tight manner. The discharge end of the housing 51 contains a steam supply discharge tube 66 and the input end of the housing 51 includes an inlet tube 65.

The housing 51 generally includes a first electrode 60, a second electrode 61, and optionally a third electrode 62, and alternately a fourth electrode 63 which are constructed of any corrosive resistant electrically conductive metal or material such as stainless steel, titanium or a graphite material. The electrodes 60-63 are generally comprised of evenly-spaced rectangular, plate-shaped structures. When using a third electrode 62 and a fourth electrode 63, multiple electrodes are supplied with a common leg of connected current. For example both the first electrode 60 and third electrode 62 would be connected to one leg (i.e. positive) of power and second electrode 61 and fourth electrode 63 would be connected to the second leg (i.e. negative or neutral) of power of the power supply (E.g. 120 V).

The specific shapes and sizes of electrodes can vary to the size and shape of the steam housing 51 but configured in a way to communicate electrical current and allow water to contact all electrodes 60-63. In some instances a liquid level notch 64 will be required to all liquid flow between electrodes 60-63, wherein the notch 64 would generally be located along a bottom edge of the electrodes 61, 62. Alternate configurations of electrodes need to maintain a spacing that ideally communicates current through water in an efficient manner. Electrical current is provided by a disconnect means such as a power supply cord and plug 69 similar to other embodiments, however alternately a hard wired power supply may be provided. An electrical connection box 68 is provided adjacent to the housing 51 to receive electrical wires 67 and provide contact connection from the power supply to the electrodes 60-63 and to take control commands from the control system 16.

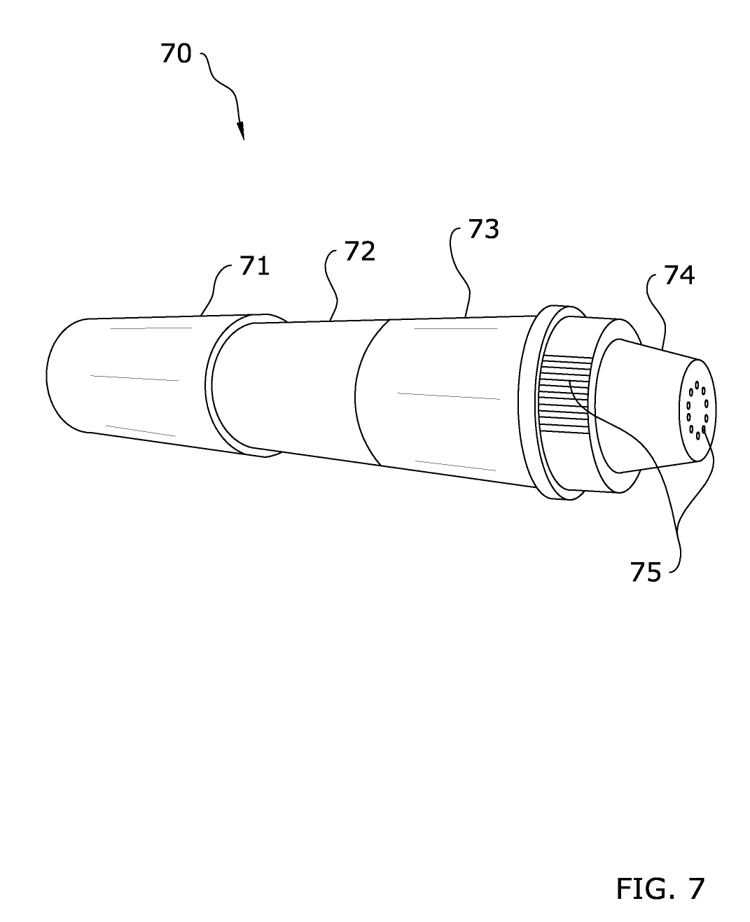

An exemplary water filter is illustrated in FIG. 7. The water filter 70 includes a base housing 71 and a water filter cap 74 to seal the housing after inserting containers 72, 73 of filter material. The filter material is packaged in individual replaceable containers. At least one replaceable container 72 of ionic material and one replaceable container 73 for alternate filter material. The filter cap 74 with water communication holes 75 controls the flow of water through the water filter 70.

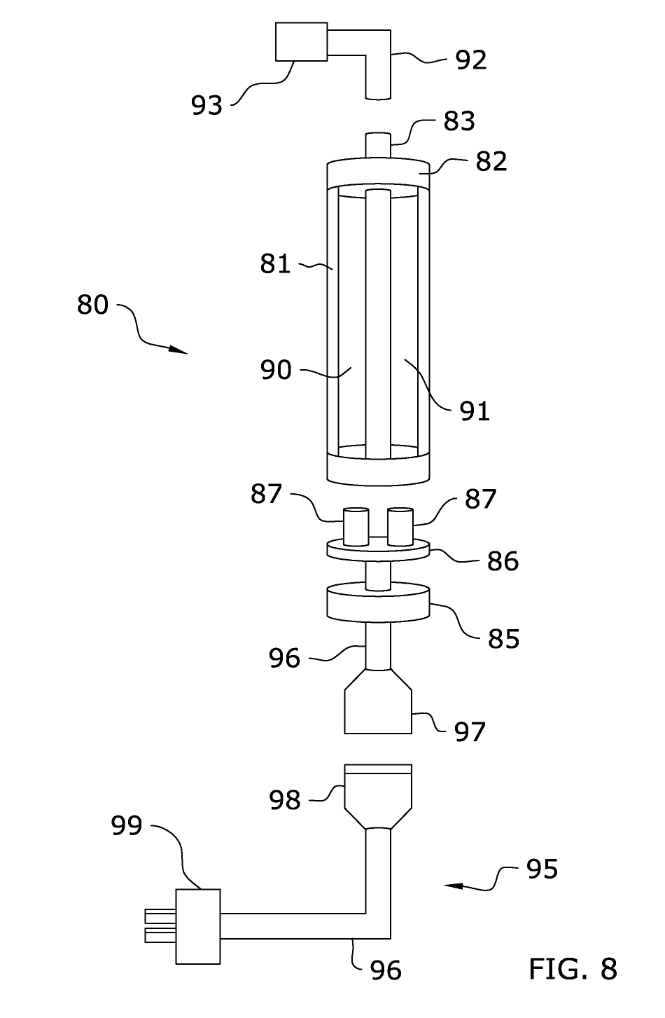

FIG. 8 illustrates another embodiment of the present invention as a determinant embodiment used to attach to an appliance requiring steam, such as a clothing steamer. The heating tank 80 includes a housing 81 of a heat resistant plastic the preferably clear or a semi-transparent heat resistant material such as polypropylene. The housing 81 can take different shapes; in a tube shape the heating tank 80 would have sealable end caps 82, 85 by means of the thread screw on each end of the housing 81 and removable caps 82, 85. Disposed within the housing 81 are the first removable electrode 90 and the second removable electrode 91. The first removable electrode 90 and the second removable electrode 91 shall be made of a conductive metal or element such as graphite and shall be positioned in such a way as to communicate current and to allow water to contact each electrode 90, 91 equally when the housing 81 is positioned in an upright position.

The first end cap 82 includes electrode recesses, a communications port for steam with a barb or other style fitting 83 for the connection of the steam supply line 92. Typically, the first end cap 82 will have an internal O-shaped ring gasket to seal against steam or water leakage. The opposite second end cap 85 incorporates an electrode mount 86 internal and separate from the second end cap 85. The electrode mount plate 86 includes mount caps 87 for receiving the ends of the electrodes 90, 91 and incorporates electrical communication devices within the caps 87 for providing power to the electrodes 90, 91. The second end cap 85 incorporates a gasket and will provide a steam and water tight seal when threaded to the housing 81. The electrode mount plate 86 and caps 87 stay stationary as the end cap 87 is rotated to complete a screw tight seal.

As illustrated in FIG. 8, the electrical supply line 95 comprises a two piece structure, and more specifically including a first connector 97 (male component) and a second connector 98 (female component) to detach the heating tank 80 from the plug 99. The electrical plug 99 extends from the wall outlet plug to the second connector 98 and when connected to the first connector 97 provides electrical current to the electrodes 90, 91 through the electrical connection within the mount caps 87. Water within the housing 81 then boils to steam which is transferred to the appliance through the supply line 92, wherein the supply line 92 is connected to an appliance through a quick connect coupling 93. Additional electrodes may be utilized as appreciated, wherein two electrodes are connected in series to each leg of the electrical supply. Each connector 97, 98 may include a safety lock for preventing accidental disengagement and also generally includes nonconductive shielding.

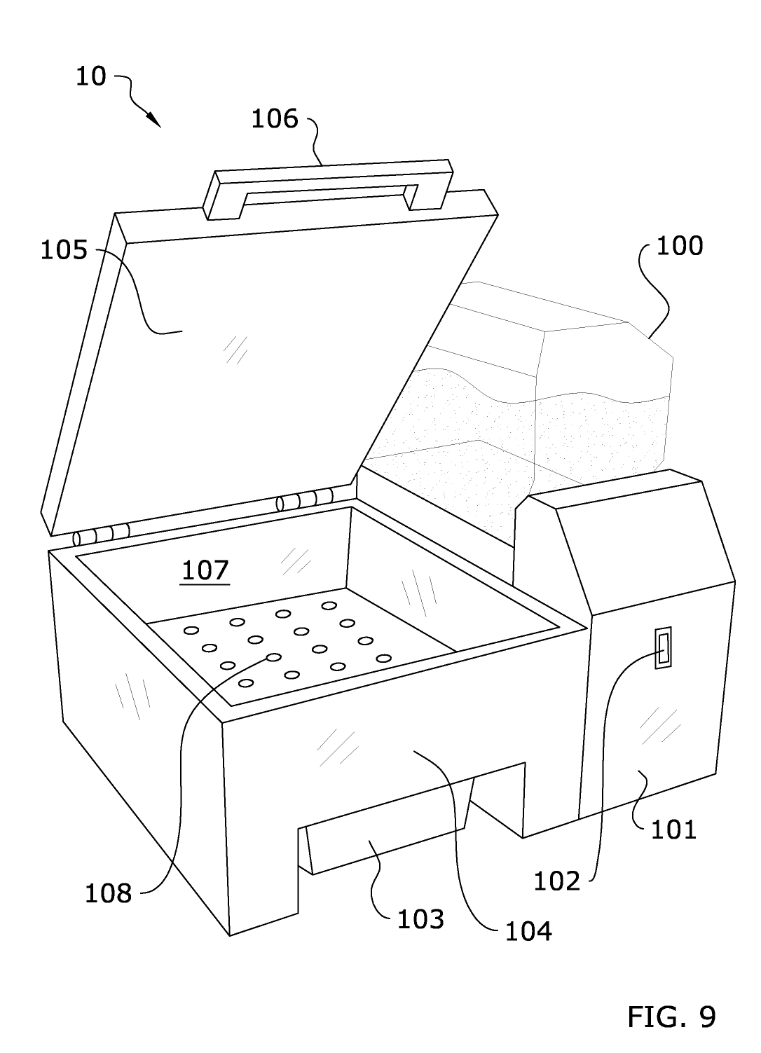

FIG. 9 illustrates a manufactured model of the present invention as to be sold to consumers for cooking, or other activities requiring the constant, intermittent, or determinant supply of steam. It is appreciated that this embodiment includes features necessary for function as illustrated in FIG. 1, such as the clear, removable, and washable reservoir 100, control box 101, condensate catch pan 103, and heating tank 104 with steam chamber 107. The reservoir 100 is removable from the control box 101 and the control box 101 generally includes the circuitry of the control system 16 as illustrated in FIG. 2. The control box 101 also includes an on/off indicator 102 among various other indicators. The condensate catch pan 103 is generally removable from under the heating tank 104, and the steam chamber 107 is above the heating tank and may receive various food or non-food items therein and includes a hinged cover 105 with handle 106. The heating chamber 107 generally includes a plurality of openings 108 along one or more adjacent surfaces leading from the heating tank 104 to permit steam to travel through.

It is also appreciated that any of the components illustrated in the different embodiments may be mixed and matched as desired or deemed necessary. It is also appreciated that the term “housing” herein may refer to structures having various sizes, such as tubular, rectangular, box-like, among others.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A steam generator system, comprising:
a source of electrolytic solution;
a pump means to deliver said electrolytic solution;
a heating tank means to receive said electrolytic solution;
electrode means comprised of at least one positive electrode and at least one negative electrode, each said electrode arranged to contact said electrolytic solution within said heating tank; and
a control means connected to said electrode means and said pump means to determine an amount of said electrolytic solution to supply to said heating tank determinant upon an amount of generated steam from said electrolytic solution desired to be outputted from said heating tank.

2. The steam generator system of claim 1, including a reservoir means for storing said source of electrolytic solution prior to said delivery to said pump.

3. The steam generator system of claim 1, including a reservoir means for storing a source of water and including a means for supplying ionic content to said water to form said source of electrolytic solution prior to said delivery to said pump.

4. The steam generator system of claim 3, wherein said means for supplying ionic content comprises an ionic supplying filter, wherein said source of water is adapted to be delivered through said ionic supplying filter to immerse said source of water with ionic content prior to storage within said reservoir means.

5. The steam generator system of claim 1, including a power supply connected for supplying a current to said pump means, said electrode means, and said control means.

6. The steam generator system of claim 1, including a check valve means fluidly connected between said pump means and said heating tank means.

7. The steam generator system of claim 1, including a cooking appliance fluidly connected to an output of said heating tank means for receiving said generated steam.

8. The steam generator system of claim 1, wherein said determination of said amount of said electrolytic solution to deliver to said heating tank means is based on a combination of ionic content added to said electrolytic solution, a level of said electrolytic solution within said heating tank as controlled by said pump, and a phase angle controller and a current sensor to adjust a current level supplied to said electrode means.

9. The steam generator system of claim 1, wherein said heating tank means comprises:
a tubular shell having a first end and a second end, wherein said tubular shell is comprised of a conductive material;
a first end cap having an input fitting and an output fitting, wherein said first end cap is attached to said first end of said tubular shell, and wherein said first end cap is comprised of a nonconductive material; and
a second end cap attached to said second end of said tubular shell, wherein said second end cap is comprised of a nonconductive material.

10. The steam generator system of claim 9, wherein said at least one positive electrode is positioned within said tubular shell adjacent said second end cap, wherein an outer diameter of said first positive electrode is less than an inner diameter of said tubular shell such that a gap is formed between said first positive electrode and said tubular shell for receiving electrolytic solution, and wherein said at least one negative electrode is comprised of said tubular shell, such that a current supplied to said at least one positive electrode travels through said electrolytic solution in said gap to said tubular shell to complete an electrical circuit and heat a water source within said electrolytic solution.

11. The steam generator system of claim 10, wherein a height of said at least one positive electrode within an interior space of said heating tank means comprises approximately one-third of a total height of said interior space, such as to permit space for an expansion chamber above said at least one positive electrode within said interior space of said heating tank means, said expansion chamber adapted to receive said generated steam.

12. The steam generator system of claim 10, wherein said at least one positive electrode has a circular cross-sectional shape to match said tubular shape of said shell.

13. The steam generator system of claim 1, wherein said heating tank means comprises:
a housing having sidewalls, a bottom, and an open top, wherein said housing is comprised of a nonconductive material and is rectangular in shape; and
a cover removably attached over said open top of said housing, wherein said cover includes a peripheral gasket sandwiched between said cover and said housing for forming a water-tight seal.

14. The steam generator system of claim 13, wherein said at least one positive electrode and said at least one negative electrode comprise a plurality of rectangular-shaped electrodes spaced evenly within an interior space of said housing.

15. The steam generator system of claim 14, wherein at least some of said plurality of rectangular-shaped electrodes have a notch formed along a lower edge to permit passage of said electrolytic solution between said at least some of said plurality of rectangular-shaped electrodes.

16. A steam generator system, comprising:
a reservoir means for storing a source of water;
a filter means leading to said reservoir means for providing ionic content to said source of water to form an electrolytic solution;
a pump means to deliver said electrolytic solution;
a heating tank means to receive said electrolytic solution;
electrode means comprised of at least one positive electrode and at least one negative electrode, each said electrode arranged to contact said electrolytic solution within said heating tank;
a control means connected to said electrode means and said pump means to determine an amount of said electrolytic solution to supply to said heating tank determinant upon an amount of generated steam from said electrolytic solution desired to be outputted from said heating tank;
wherein said determination of said amount of said electrolytic solution to deliver to said heating tank means is based on a combination of ionic content added to said electrolytic solution, a level of said electrolytic solution within said heating tank as controlled by said pump, and a phase angle controller and a current sensor to adjust a current level supplied to said electrode means; and
a power supply connected for supplying a current to said pump means, said electrode means, and said control means.

17. The steam generator system of claim 16, wherein said heating tank means comprises:
a tubular shell having a first end and a second end, wherein said tubular shell is comprised of a conductive material;
a first end cap having an input fitting and an output fitting, wherein said first end cap is attached to said first end of said tubular shell, and wherein said first end cap is comprised of a nonconductive material; and
a second end cap attached to said second end of said tubular shell, wherein said second end cap is comprised of a nonconductive material.

18. The steam generator system of claim 17, wherein said at least one positive electrode is positioned within said tubular shell adjacent said second end cap, wherein an outer diameter of said first positive electrode is less than an inner diameter of said tubular shell such that a gap is formed between said first positive electrode and said tubular shell for receiving electrolytic solution, and wherein said at least one negative electrode is comprised of said tubular shell, such that a current supplied to said at least one positive electrode travels through said electrolytic solution in said gap to said tubular shell to complete an electrical circuit and heat a water source within said electrolytic solution.

19. The steam generator system of claim 18, wherein a height of said at least one positive electrode within an interior space of said heating tank means comprises approximately one-third of a total height of said interior space, such as to permit space for an expansion chamber above said at least one positive electrode within said interior space of said heating tank means, said expansion chamber adapted to receive said generated steam and wherein said at least one positive electrode has a circular cross-sectional shape to match said tubular shape of said shell.

20. A steam generator system, comprising:
a source of electrolytic solution;
a heating tank means to receive said electrolytic solution;
electrode means comprised of at least one positive electrode and at least one negative electrode each positioned within said heating tank, each said electrode arranged to contact said electrolytic solution within said heating tank;
an electrical supply line having a detachable plug, said electrical supply line connected to a first end of said heating tank for providing electrical current to said electrode means;
a steam delivery means having a coupler, said steam delivery means connected to a second end of said heating tank for outputting a generated steam from said electrolytic solution; and
an appliance connected to said coupler for using said generated steam.
